(19) United States
(12) Patent Application Publication
(10) Pub. No.: US 2026/0066670 A1
(43) Pub. Date: Mar. 5, 2026

(54) VARIABLE DROOP CONTROL WITH ADAPTIVE STATE OF CHARGE

(71) Applicant: Emera US Holdings Inc., Tampa, FL (US)

(72) Inventors: Seyyed Ali Ghorashi Khalil Abadi, Albuquerque, NM (US); Daniel Bauer, Albuquerque, NM (US)

(73) Assignee: Emera US Holdings Inc., Tampa, FL (US)

(21) Appl. No.: 19/281,054

(22) Filed: Jul. 25, 2025

Related U.S. Application Data
(60) Provisional application No. 63/691,170, filed on Sep. 5, 2024.

(51) Int. Cl. H02J 7/34; H02J 7/00

(52) U.S. Cl. CPC H02J 7/34; H02J 7/52; H02J 7/82; H02J 7/96; H02J 2207/20

(57) ABSTRACT

Variable droop control for a direct current microgrid that has a plurality of parallel grid-forming battery energy storage systems. The droop control mitigates against discrepancies in the state of charge of such battery energy storage systems. The droop control is dynamically adaptive, ensures safety and stability for the battery stacks while providing drooping and dedrooping at rates that maintain transient stability of the direct current microgrid without degrading the quality of the direct current bus. Embodiments of the invention measure a state of charge of each battery stack of each of the battery energy storage systems and computes an average state of charge for the battery energy storage systems.

### CROSS-REFERENCE TO RELATED APPLICATIONS

This application claims priority to and the benefit of the filing of U.S. Provisional Patent Application No. 63/691,170, entitled “Variable Droop Control with Adaptive State of Charge”, filed on Sep. 5, 2024, and the specification thereof is incorporated herein by reference.

### COPYRIGHTED MATERIAL

© 2024 Emera US Holdings Inc. A portion of the disclosure of this patent document and of the priority application listed above contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

Microgrids (“MGs”) represent a paradigm shift in the realm of electricity distribution networks, aiming to augment the capabilities of traditional power systems. These enhancements include bolstering consumer participation, integrating sustainable energy resources, improving power system stability, and enhancing grid resiliency. Among various types, direct current microgrids (“DC MGs”) have emerged as a focal point of interest owing to their reduced power conversion losses and simplified control mechanisms when compared to their alternating current (“AC”) counterparts. The attributes of DC MGs position them as practical solutions for rural electrification, strengthening the resilience of power grids, and fostering the development of local energy communities.

Grid-forming Distributed Energy Resources (“DERs”) play a pivotal role in the reliable operation of DC MGs. These resources are crucial for maintaining voltage stability and ensuring a balance between generation and load within the microgrid. Their ability to regulate the microgrid's voltage and power balance positions them as essential components for the system's overall functionality and resilience, particularly in scenarios where the microgrid operates in islanded mode or integrates a significant amount of renewable energy sources.

In this context, the role of droop control as a mechanism for proportional power sharing among parallel grid-forming resources in DC MGs has been widely recognized. Droop control facilitates the distribution of power loads among different energy sources within the microgrid, crucial for maintaining operational balance and efficiency. However, the inherent uncertainties and inaccuracies associated with measurement processes or ineffective state of charge (“SoC”) estimation pose significant challenges. These can lead to discrepancies in the SoC of Battery Energy Storage Systems (“BESSs”) after mid-term operation, ranging from a few days to several months. Such SoC imbalances can jeopardize the stability and reliability of the system by risking the loss of one or multiple resources within the microgrid.

Traditional adaptive droop gain correction systems aim to adjust droop control parameters based on the SoC of the batteries. Despite their potential, these systems can induce substantial variations in droop gain, leading to significant voltage deviations. They may also create scenarios where one battery inadvertently charges others while collectively serving the microgrid load, thereby diminishing system efficiency and escalating power losses. In addition, they may overload converters threatening the stability of the system in edge conditions. Moreover, rapid changes in droop gain can cause voltage sags or swells, threatening the transient stability of DC MGs or degrading the quality of the direct current (“DC”) bus voltage.

What is needed is a system that not only balances the State of Charge among batteries within DC microgrids but also enhance the overall system efficiency, reliability, and operational stability. By addressing the limitations of current droop control strategies, the needed system preferably ensures a balanced and efficient energy distribution, contributing significantly to the advancement of DC microgrid technology.

### BRIEF SUMMARY OF EMBODIMENTS OF THE PRESENT INVENTION

Embodiments of the present invention are directed to a variable droop control system with adaptive-safe state of charge balancing capability for parallel grid forming battery energy storage systems in DC microgrids.

Embodiments of the present invention relate to a method of variable-droop state of charge (“SoC”) correction for a plurality of parallel grid-forming battery energy storage systems (“BESSs”), each of the BESSs having at least one battery stack, the method including measuring a voltage of each of the at least one battery stack to determine a SoC for each of the plurality of parallel grid-forming BESSs, computing an average SoC of the plurality of parallel grid-forming BESSs for a microgrid, calculating an unsaturated droop adjustment value for at least one of the plurality of parallel grid-forming BESSs, dynamically adjusting a droop gain limit for the at least one of the plurality of parallel grid-forming BESSs based at least in part on loading of a grid-forming converter of the at least one of the plurality of grid-forming BESSs, calculating a saturated droop gain adjustment value, applying a droop gain to the at least one of the plurality of parallel grid-forming BESSs without exceeding the calculated saturated droop gain adjustment value, and dedrooping the at least one of the plurality of parallel grid-forming BESSs by calculating a reference voltage for the grid-forming converter using the saturated droop gain adjustment value. In one embodiment, calculating an unsaturated droop adjustment value can include determining a difference between the computed average SoC and the determined SoC of the at least one of the plurality of parallel grid-forming BESSs, and can further include multiplying the determined difference by a sign of an inductor current of the grid-forming converter.

The method can also include scaling the calculated unsaturated droop adjustment value by a capacity ratio of the of the at least one of the plurality of parallel grid-forming BESSs to account for a relative power capacity. In one embodiment the method can also include applying a factor to adjust a convergence rate of the determined SoC for the at least one of the plurality of parallel grid-forming BESSs. Optionally, the computed average SoC of the plurality of parallel grid-forming BESSs can be communicated to a droop gain calculator of each of the plurality of parallel grid-forming BESSs.

In one embodiment, calculating the unsaturated droop adjustment value can include first determining a difference between the computed average SoC of the plurality of parallel grid-forming BESSs and the SoC of all battery stacks connected to the grid-forming converter. Dynamically adjusting the droop gain limit can include preventing overloading by dynamically adjusting the droop gain adjustment based on a loading condition of the grid-forming converter. Dynamically adjusting a droop gain limit can further include applying an adjustable parameter to adjust a range of the droop gain limit. Calculating the saturated droop gain adjustment value can include dynamically restricting the unsaturated droop adjustment value to a percentage or other proportional relationship of a basic droop gain, based on real-time system parameters.

The method can also include compensating for voltage drop by calculating the reference voltage for a grid-forming converter using the saturated droop gain adjustment value, calculating a voltage drop caused by droop control for each grid-forming converter of the of the plurality of parallel grid-forming BESSs, and calculating an average of the voltage drops of all grid-forming converters of the plurality of parallel grid-forming BESSs and adding the average of the voltage drops to the reference voltage for each of the grid-forming converters.

In one embodiment, the method can also include calculating the reference voltage for a grid-forming converter using the saturated droop gain adjustment value. In the method, applying droop gain to the at least one of the plurality of parallel grid-forming BESSs without exceeding the calculated saturated droop gain adjustment value can include applying the saturated droop gain adjustment value in response to the detection of SoC discrepancies among batteries exceeding a predetermined criteria. The predetermined criteria can include a SoC of the batteries not deviating by more than 80% between a highest state of charge and a lowest SoC.

Embodiments of the present invention also relate to a variable-droop state of charge (“SoC”) management system for a direct current microgrid having a plurality of parallel grid-forming battery energy storage systems (“BESSs”), the system including each of the plurality of parallel grid-forming BESSs having at least one battery stack, a processor and/or microcontroller configured and coupled to measure a voltage of each of the at least one battery stack to determine a SoC for each of the plurality of parallel grid-forming BESSs, the processor and/or microcontroller configured to compute an average SoC of the plurality of parallel grid-forming BESSs, calculate an unsaturated droop adjustment value for at least one of the plurality of parallel grid-forming BESSs, dynamically adjust a droop gain limit for the at least one of the plurality of parallel grid-forming BESSs based at least in part on loading of a grid-forming converter of the at least one of the plurality of grid-forming BESSs, calculate a saturated droop gain adjustment value, apply a droop gain to the at least one of the plurality of parallel grid-forming BESSs without exceeding the calculated saturated droop gain adjustment value, and dedroop the at least one of the plurality of parallel grid-forming BESSs by calculating a reference voltage for the grid-forming converter using the saturated droop gain adjustment value. The processor and/or microcontroller can be further configured to determine a difference between the computed average SoC and the determined SoC of the at least one of the plurality of parallel grid-forming BESSs. The processor and/or microcontroller can be further configured to apply a factor to adjust a convergence rate of the determined SoC for the at least one of the plurality of parallel grid-forming BESSs. In one embodiment, the variable-droop SoC management system can be configured to prevent overloading by dynamically adjusting the droop gain adjustment based on a loading condition of the grid-forming converter. The processor and/or microcontroller can be further configured to dynamically restrict the unsaturated droop adjustment value to a percentage or other proportional relationship of a basic droop gain, based on real-time system parameters. The processor and/or microcontroller can be further configured to apply the saturated droop gain adjustment value in response to the detection of SoC discrepancies among batteries exceeding a predetermined threshold.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. While some of the drawings indicate certain dimensions, embodiments of the present invention can be of varying dimensions depending on the intended use. Although the description describes various “steps” embodiments of the present invention can function and can provide desirable results if one or more additional intervening steps are also added. In the drawings:

FIG. 1 is a drawing of a diagram illustrating a first step of the variable-droop SoC correction method according to an embodiment of the present invention;

FIG. 2 is a drawing of a diagram illustrating a second step of the variable-droop SoC correction method according to an embodiment of the present invention;

FIG. 3 is a drawing of a diagram illustrating a third step of the variable-droop SoC correction method according to an embodiment of the present invention;

FIG. 4 is a drawing of a diagram illustrating a fourth step of the variable-droop SoC correction method according to an embodiment of the present invention;

FIG. 5 is a drawing of a diagram illustrating a fifth step of the variable-droop SoC correction method according to an embodiment of the present invention;

FIG. 6 is a drawing of a diagram illustrating a sixth step of the variable-droop SoC correction method according to an embodiment of the present invention; and

FIG. 7 is a drawing that illustrates inputs, parameters, and initial values of a code for the variable-droop SoC correction method according to an embodiment of the present invention.

### DETAILED DESCRIPTION OF THE INVENTION

Embodiments of the present invention relate to an advanced variable droop control system that preferably includes an adaptive-safe State of Charge balancing feature, tailored for grid-forming parallel Battery Energy Storage Systems within DC microgrids. Unlike traditional droop control systems, which are fundamental for proportional power distribution among parallel grid-forming resources but struggle to maintain SoC balance due to inaccuracies and uncertainties, embodiments of the present invention address and overcome such challenges. The discrepancies of traditional systems compromise the microgrid's stability and reliability, risking resource loss over mid-term operation periods.

Embodiments of the present invention not only dynamically adjust based on the SoC of the batteries but dynamically limit both the rate of change and the range of droop gain variation to a predetermined portion of the basic droop gain. This dual limitation methodology and system effectively prevents significant voltage deviations and enhances the overall system efficiency, addressing the drawbacks of conventional adaptive droop gain adjustments that often lead to voltage fluctuations, reduced efficiency, and transient stability issues. By ensuring balanced SoC among batteries and meticulously controlling both the rate and range of droop gain variation, the invention significantly bolsters the DC microgrid's stability and reliability, thereby benefiting infrastructures and applications dependent on consistent, reliable power.

Embodiments of the present invention minimize the inefficiencies and power losses associated with inter-battery charging and excessive droop gain adjustments that occur in traditional systems. Optimized power sharing and SoC balancing lead to a more efficient microgrid operation. Embodiments of the present invention also provide precise control over the droop gain variation. In addition, its rate of change mitigates the risk of voltage sags or swells, thus enhancing the transient stability and voltage quality of the DC bus. This improvement is crucial for the uninterrupted operation of sensitive electronic devices connected to the microgrid.

The present invention's increased efficiency and reliability translate into cost savings through reduced maintenance needs, fewer operational disruptions, and extended battery life, yielding a higher return on investment for microgrid operators. Designed to be flexible and scalable, this variable droop control system with adaptive-safe SoC balancing can be applied to a variety of DC microgrid configurations. It is also scalable to accommodate future energy storage demands, making it a forward-thinking solution for grid enhancements. This refined approach not only addresses the limitations of existing droop control methods but also introduces a novel solution for managing and operating DC microgrids more reliably, efficiently, and sustainably.

Referring now to the figures, the variable-droop SoC correction method of embodiments of the present invention is a method and apparatus that provide an adaptive multi-step approach that address and rectify the challenges associated with proportional power sharing and State of Charge balancing among parallel grid-forming Battery Energy Storage Systems within DC microgrids. This method is meticulously crafted to enhance the microgrid's operational stability, efficiency, and reliability by intelligently adjusting the droop gain based on real-time SoC data and system loading conditions. The method preferably incorporates a series of interconnected steps, starting from the calculation of an average SoC for all BESSs, through to the dynamic adjustment of droop gain and the careful control of its rate of change. The method and apparatus ensure that voltage quality is maintained at optimal levels, thereby safeguarding against voltage sags or swells, and enhancing the overall performance of the microgrid. Below is a detailed step-by-step implementation of a most preferred embodiment of the method and of the steps performed by the apparatus, which describe a systematic approach to improving DC microgrid operations. The following steps are meant to illustrate a most preferred embodiment of the present invention, but it is important to keep in mind that one or more other intervening steps can optionally be performed as may be desirable for a particular application or implementation.

### Step 1: Average State of Charge (SoC) Calculation

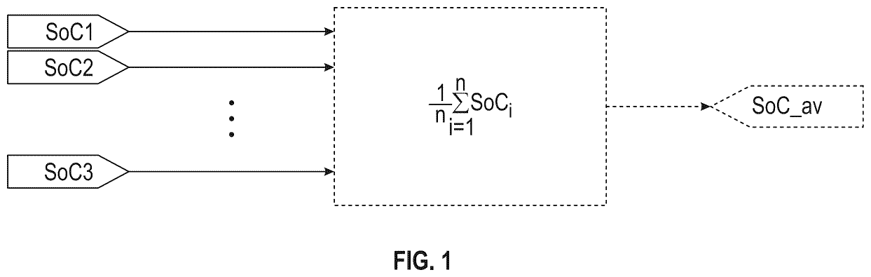

FIG. 1 illustrates Step 1, which includes computing or otherwise calculating the average SoC of all parallel grid-forming BESSs. The calculated average SoC value is preferably then communicated to the droop gain calculation block of each grid-forming BESS. Optionally, however, the calculated average SoC value can be stored and each grid-forming BESS can be configured to retrieve it from its stored location. This step ensures that subsequent adjustments to the droop gain are based on a holistic view of the energy storage capacity and utilization across the microgrid.

Step 1 preferably calculates the average state of charge of all of the parallel grid forming BESSs, then preferably sends this value to a droop gain calculation block of each grid forming BESS. As illustrated in FIG. 1, SoC of the specific battery (“SoCi”) means the average SoC (“SoC_av”) of all the battery stacks connected to the i^{th} converter. So, if there are two active converters and each of them has two battery stacks, the SoC1 will be average SoC of all battery stacks at converter 1 and SoC2 is the average SoC of all battery stacks connected to converter 2. In one embodiment, the voltage of each battery stack is measured to determine its SoC. Optionally, the SoC can be derived or otherwise obtained directly from a battery management system. Then, the average SoC (SoC_av) can be calculated as SoC_av=(SoC1+SoC2)/2.

### Step 2: Calculation of Raw/Unsaturated Droop Adjustment Value (∂Rd)*

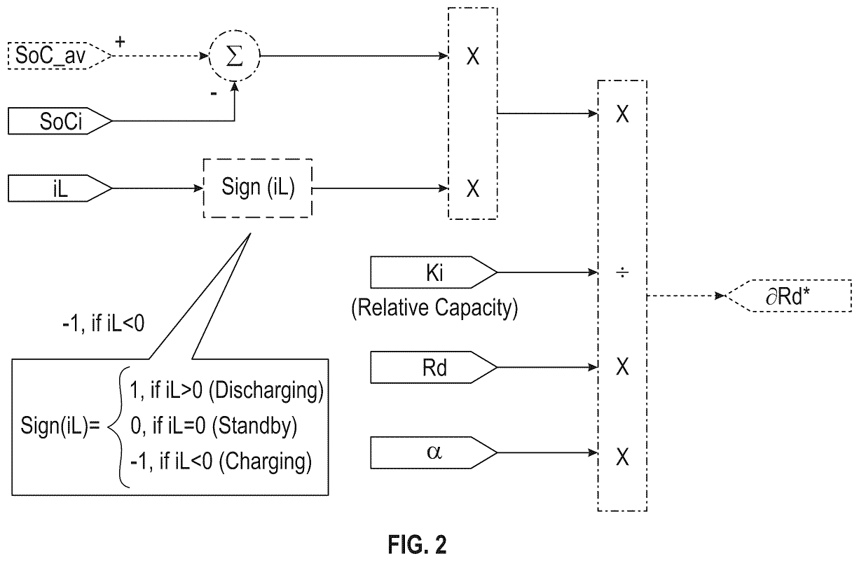

As illustrated in FIG. 2 and Step 2, the raw or unsaturated value of the droop adjustment term, denoted as ∂Rd*, is preferably computed by first determining the difference between the average SoC (SoC_av) and the SoC of the specific battery. This difference is then multiplied by the sign of the inductor current of the BESS's grid-forming converter (“iL”), and the result is preferably further scaled by the battery's capacity ratio (1/ki) to account for the relative power capacity of the energy storage system. Sign(iL) is 1 if iL>0 (discharging), 0 if iL=0 (standby), or −1 if iL<0 (charging). An additional factor, α, is applied to adjust the SoC convergence rate, with a value preferably in the range of 1 to 10 (1<α<5), optimizing the speed and responsiveness of the SoC balancing process. α also controls the rate of SoC convergence for parallel grid-forming batteries, thereby enhancing the system's response time. This approach dynamically accelerates SoC balancing, while ensuring system stability through the consideration of saturation limits in subsequent steps.

In one embodiment, Ki illustrates the relative rated capacity of batteries connected to each converter. This value can be changed when a battery module fails during system operation. For example, all the batteries connected to the 3 parallel grid-forming converters (“GFM converters”) can have the same rated capacity (for example, 300 Ah). Initially, Ki, which is the relative rated capacity, is equal for all three converters and is 1 (K1=K2=K3=1). Then, let's assume during the system operation, half of the battery modules connected to converter 3 fail. So, the rated battery capacity connected to the converter 3 will be 150 Ah. Therefore, the relative rated capacities for batteries are obtained as K1=1 (300), K2=1 (300/300), and K3=0.5 (150/300). So, a controller, which can optionally include a programmable logic controller (“PLC”), application specific integrated circuit (“ASIC”), microprocessor, microcontroller, other system, circuit, software, or a combination thereof preferably updates Ki value for each converter to guarantee the desired operation of the system.

Step 2 preferably also provides an accelerated system response which improves the rate at which SoC imbalances are corrected across batteries, thus enhancing the overall responsiveness of the system to changes in demand or supply. Step 2 preferably also provides for controlled SoC convergence, which allows for the adjustment of the SoC convergence rate without risking transient voltage fluctuations or overloading conditions, thereby providing a balance between rapid response and system stability.

In one embodiment, α, which is the convergence speed adjustable parameter, can optionally be equal for all the grid forming converters. For example, for high-speed convergence, α=5 can optionally be used for all the three converters in the controllers. Then, if they decide to reduce the convergence speed, for all the three GFM converters, the value of a should reduce to 1 (α=1).

### Step 3: Determination of Dynamic Droop Gain Adjustment Limit

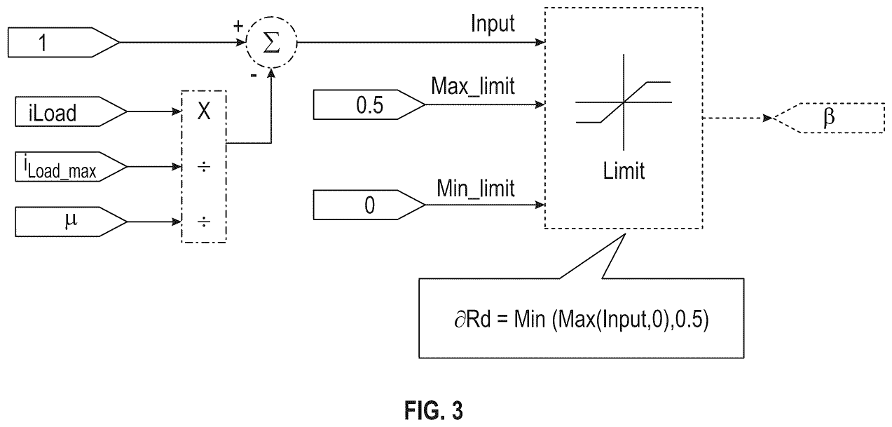

As illustrated in FIG. 3, Step 3 establishes a dynamic limit for adjusting the droop gain, based on the loading condition of the converter to prevent overloading in edge conditions. By setting this limit, the system ensures that adjustments to the droop gain do not compromise the operational integrity or efficiency of the converter, especially under conditions of high demand or stress. This limit is dynamically adjusted based on the converter loading to avoid overloading the converter in edge condition. There is also an adjustable parameter (“μ”) which can control the range of the dynamic droop gain adjustment. In one embodiment, μ is preferably selected in the range of 0<μ<about 0.8 to ensure the avoidance of overloading the converter in edge conditions. In one embodiment, a dynamic droop gain adjustment limit can be determined using the following formula:

Dynamic droop gain adjustment limit=1−(load current/max load current/μ)

Step 3 introduces a dynamic droop gain adjustment limit based on the converter's loading condition. The ability to dynamically adjust this limit ensures that the converter is not overloaded, particularly in edge conditions where the system is most vulnerable. By preventing the overloading of converters, Step 3 directly contributes to maintaining system stability under varying operational conditions.

### Step 4: Calculation of Limited/Saturated Droop Gain Adjustment Value (∂Rd)

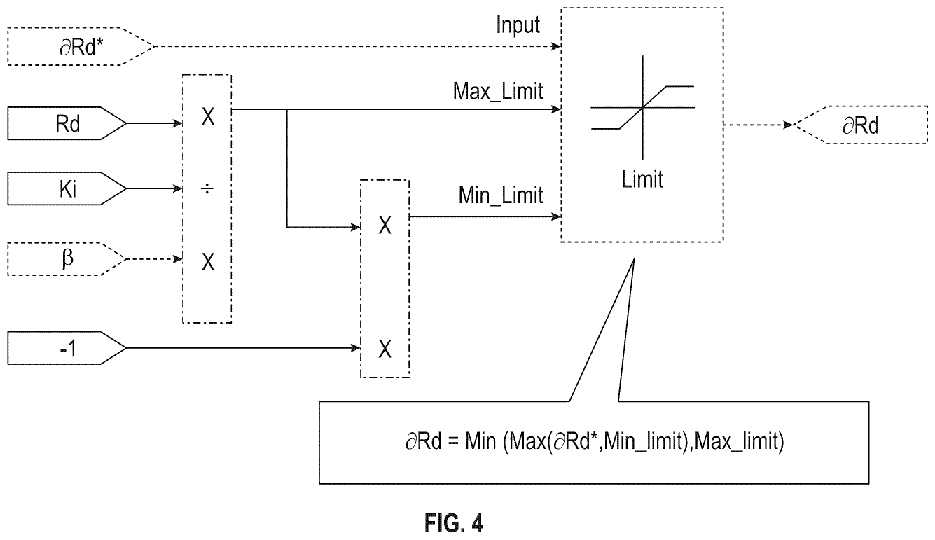

FIG. 4 illustrates Step 4. The limited or saturated droop gain adjustment value, ∂Rd, is preferably derived by dynamically restricting the raw droop adjustment (∂Rd*) to 100% of the basic droop gain (Rd/ki). This adjustment process is made adaptable to changes in the basic droop gain values, as the saturation limits dynamically evolve in response to variations in Rd and Ki values. The β factor represents the ratio of maximum ∂Rd to the basic droop gain in percentage, ensuring that adjustments are proportional and maintain system stability.

Step 4 dynamically limits the droop gain adjustment (∂Rd) to a predetermined percentage or other proportional relationship of the basic droop gain, based on real-time system parameters. In one embodiment, the predetermined percentage can be determined heuristically based on the grid-forming converters, loads, and sources used in the particular application and the acceptable impact that the rate of change of droop gain has on the voltage stability of the voltage bus regulated by the grid-forming converters. The real-time parameters can include the total capacity of the operating energy storage behind the operating converter, the present droop impedance of the converter, and the output of Step 3.

This addresses the critical challenge of avoiding significant voltage deviations that can arise from abrupt changes in droop gain. By ensuring that adjustments are within a safe and calculated limit, it enhances the system's stability and reliability, especially under conditions that would traditionally stress the microgrid.

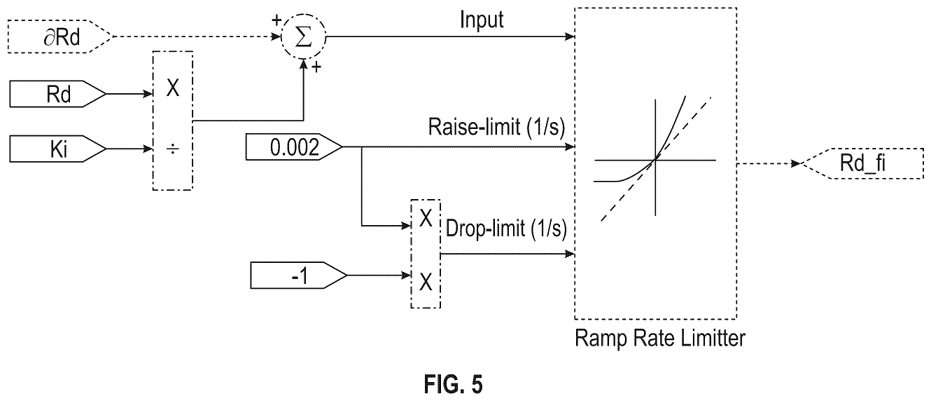

Step 5: Application of the Droop Gain (Rd_fi) FIG. 5 illustrates Step 5. Step 5 involves the application of the droop gain, within the droop control system. In one embodiment, it is specifically selected to limit the rate of change of the droop to a predetermined rate (which can optionally include for example a rate of about 0.002 (0.2%) per second), thus facilitating a smooth transition in droop values and preventing transient voltage oscillations at the microgrid's DC bus. This meticulous control over the droop gain's rate of change is preferred for maintaining voltage quality and ensuring stable operation. The rate of change can be determined empirically for a specific DC microgrid system. In one embodiment, the rate of change of droop and its impact on the microgrid DC bus stability is a function of the load conditions, bandwidths of the grid-forming converter's current, voltage, and voltage droop regulation loops, the number of grid-forming converters operating in the system, and the specific tolerance of transient voltage conditions on the microgrid bus.

Step 5 provides for explicit control over the rate of change of the droop gain, limiting it to a specific threshold. This feature is preferred for mitigating transient voltage deviations. The output of Step 5 is the droop gain applied to the converter, a rate of change limiter is preferably applied to the input to Step 5 to produce this value. This solves the problem of transient voltage spikes or drops that can occur with rapid changes in the droop setting, ensuring a smooth and stable voltage profile. It is preferred for maintaining the quality of power delivered to sensitive loads and for the overall stability of the DC microgrid.

### Step 6: Calculation of the Grid-Forming Converter's Reference Voltage

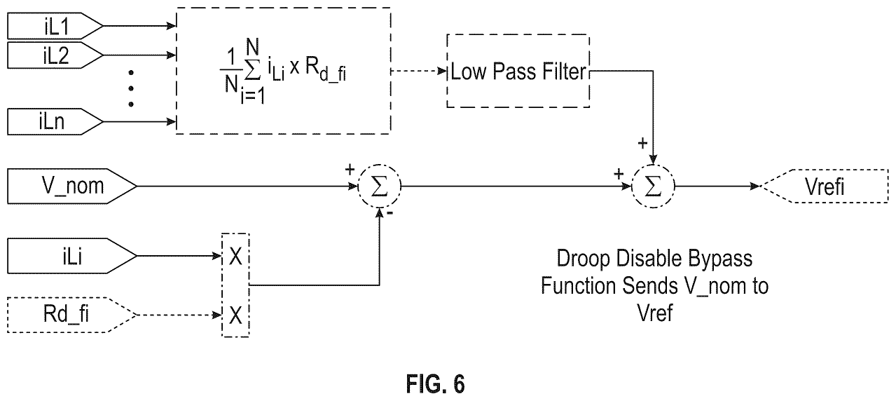

Finally, FIG. 6 illustrates Step 6. A dedrooping mechanism is preferably incorporated at this stage to mitigate steady-state voltage drops at the DC bus caused by reductions in droop, thereby enhancing the voltage quality of the DC microgrid and ensuring consistent, reliable power delivery to connected loads. The dedrooping mechanism calculates the voltage drop caused by droop control for each converter separately and then calculates the average of these voltage drops using the equation given in FIG. 6. Then, it adds that value to the reference voltage for all the converters to compensate for the voltage drop caused by the droop approach.

Steps 1-6 demonstrate a comprehensive and carefully considered strategy for enhancing DC microgrid management through advanced droop control adjustments, thus providing significant improvements in system performance and energy efficiency.

In one embodiment, the variable-droop SoC correction method of an embodiment of the present invention preferably implements the following set of rules for adjusting the droop gain in response to SoC discrepancies among batteries, maintaining balance and stability within the microgrid by realigning SoC levels once they exceed a certain threshold (see for example FIG. 6).

FIG. 6 illustrates how the adjusted droop gain is used to calculate the reference voltage for the grid-forming converter. The algorithm illustrated in FIG. 6 has three parts and it calculates the reference voltage of the ith converter. In particular, Rd_fi is the final droop gain calculated for ith converter shown in FIG. 5., and iLi is the inductor current of the ith converter. These values are multiplied to obtain the voltage drop for ith converter. V_nom is the nominal voltage of the DC MG. The voltage drop is then deducted from the nominal voltage of the DC MG. Then, dedroop term is added to the dropped voltage to calculate the Vref, which is the reference voltage of the ith converter (Vrefi). As illustrated, the dedroop term is preferably calculated by first calculating the average voltage drop by all the parallel converters. Then, it is passed through a linear time invariant (“LTI”) low pass filter. Then, the calculated dedroop term is preferably added to obtain Vrefi.

In summary, the system of FIG. 6 preferably adjusts the droop gain based on the SoC discrepancies, charging or discharging status of the BESS and system parameters. This actively addresses SoC imbalances, ensuring prompt adjustments to maintain system balance.

In another embodiment of the present invention, the variable-droop SoC correction method can adjust the droop gain dynamically based on SoC levels, with a fixed adaptability rate, to balance SoC across batteries but without mechanisms to prevent overload or mitigate voltage deviations. This leverages real-time SoC data to inform droop control adjustments, enhancing the potential for maintaining battery balance.

In one embodiment, the variable droop control system can be used for parallel grid forming BESSs and is not used for power sharing between BESS and photovoltaic (“PV”) with a constraint on PV generation. In one embodiment, the variable droop control system has a defined control limit to adjust the droop gain and its rate of change—this provides less transient voltage deviation. In one embodiment, the variable droop control system has external limiting for droop gain rate of change and does not have value adjustment based on converter loading. In one embodiment, the variable droop control system does not have nonlinear behavior. In one embodiment, the variable droop control system is not based on DC voltage signaling for SoC balancing.

### INDUSTRIAL APPLICABILITY

The invention is further illustrated by the following non-limiting example.

### Example 1

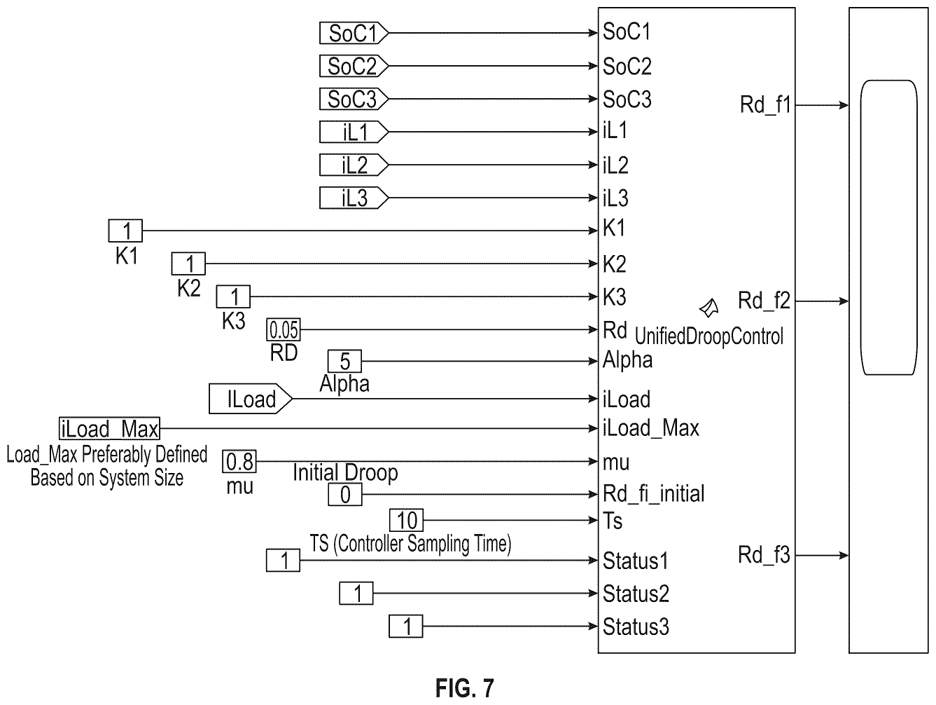

In addition to the block box representation of the variable-droop SoC correction method depicted above in Steps 1-6 (and FIGS. 1-6), code for implementing an embodiment of this method and system is also depicted below. The code has been tested in the SIMULINK® (a registered trademark of Mathworks Inc.) environment containing a dynamic model of a microgrid, and its performance has been verified. In one embodiment, some minor changes on the parameters can be applied in the final implementation—for example, by adjusting the rate of change limit and convergence speed. The inputs/parameters and the initial values of the code are illustrated in FIG. 7 and the code is illustrated below. Note that the drooping step is not included in this code and the defined value for Rd_f_initial can be changed based on how the system is going to start the operation.

```
function [Rd_f1, Rd_f2, Rd_f3] = unifiedDroopControl(SoC1, SoC2, SoC3, iL1, iL2, iL3, K1, K2, K3, Rd,
alpha, iLoad, iLoad_max, mu, Rd_fi_initial, Ts, status1, status2, status3)
  % Main function to perform droop control adjustments across battery management
  % This function includes status checks for each converter (on=1, off=0)
  % Inputs:
  % SoC1, SoC2, SoC3: State of Charge for each battery
  % iL1, iL2, iL3: Inductor currents for each battery
  % K1, K2, K3: Battery capacities
  % Rd: Base droop resistance
  % alpha: Adjustment factor
  % iLoad: Current load
  % iLoad_max: Maximum load
  % mu: Scaling factor for the load
  % Rd_fi_initial: Initial droop resistance for rate limiting
  % Ts: Sampling time
  % status1, status2, status3: Status of each battery's converter (1=on, 0=off)
  % Step 0: Calculate average State of Charge based on the status of converters
  SoC_av = calculateAverageSoC(SoC1, SoC2, SoC3, status1, status2, status3);
  % Step 1: Calculate initial droop adjustments
  [Delta_Rd1_star, Delta_Rd2_star, Delta_Rd3_star] = calculateDroopAdjustments(SoC_av, SoC1,
SoC2, SoC3, iL1, iL2, iL3, K1, K2, K3, Rd, alpha);
  % Step 2: Calculate droop gain limit
  beta = calculate DroopGainLimit(iLoad, iLoad_max, mu);
  % Step 3: Calculate all limited droop gains
  [Delta_Rd1, Delta_Rd2, Delta_Rd3, ~] = calculateAllLimitedDroopGains(Delta_Rd1_star,
Delta_Rd2_star, Delta_Rd3_star, Rd, K1, K2, K3, beta);
  % Step 4: Calculate final droop gains with rate limiting
  [Rd_f1, Rd_f2, Rd_f3] = calculateDroopGains(Delta_Rd1, Delta_Rd2, Delta_Rd3, Rd,
Rd_fi_initial, K1, K2, K3, Ts);
end
% Function to calculate average State of Charge based on converter status
function SoC_av = calculateAverageSoC(SoC1, SoC2, SoC3, status1, status2, status3)
  % Compute the average State of Charge, considering only active converters
  totalSoC = 0;
  count = 0;
  if status1 == 1
    totalSoC = totalSoC + SoC1;
    count = count + 1;
  end
  if status2 == 1
    totalSoC = totalSoC + SoC2;
    count = count + 1;
  end
  if status3 == 1
    totalSoC = totalSoC + SoC3;
    count = count + 1;
  end
  if count > 0
    SoC_av = totalSoC / count;
  else
    SoC_av = 0; % Default to 0 if all converters are off
  end
end
% Helper function to calculate initial droop adjustments for each battery
function [Delta_Rd1_star, Delta_Rd2_star, Delta_Rd3_star] = calculateDroopAdjustments(SoC_av,
SoC1, SoC2, SoC3, iL1, iL2, iL3, K1, K2, K3, Rd, alpha)
  sign_iL1 = sign(iL1);
  Delta_Rd1_star = (SoC_av − SoC1) * sign_iL1 * 0.01 * (1/K1) * alpha * Rd;
  sign_iL2 = sign(iL2);
  Delta_Rd2_star = (SoC_av − SoC2) * sign_iL2 * 0.01 * (1/K2) * alpha * Rd;
  sign_iL3 = sign(iL3);
  Delta_Rd3_star = (SoC_av − SoC3) * sign_iL3 * 0.01 * (1/K3) * alpha * Rd;
end
% Function to limit the beta value for droop gain adjustments
function beta = calculateDroopGainLimit(iLoad, iLoad_max, mu)
  input = 1 − (iLoad / (iLoad_max * mu));
  beta = max(min(input, 0.5), 0);
end
% Function to calculate limited droop gains based on the initial adjustments and beta
function [Delta_Rd1, Delta_Rd2, Delta_Rd3, Max_limit3] =
calculateAllLimitedDroopGains(Delta_Rd1_star, Delta_Rd2_star, Delta_Rd3_star, Rd, K1, K2, K3, beta)
  Min_limit1 = −Rd * beta / K1;
  Max_limit1 = Rd * beta / K1;
  Delta_Rd1 = max(min(Delta_Rd1_star, Max_limit1), Min_limit1);
  Min_limit2 = −Rd * beta / K2;Max_limit2 = Rd * beta / K2;
  Delta_Rd2 = max(min(Delta_Rd2_star, Max_limit2), Min_limit2);
  Min_limit3 = −Rd * beta / K3;
  Max_limit3 = Rd * beta / K3;
  Delta_Rd3 = max(min(Delta_Rd3_star, Max_limit3), Min_limit3);
end
% Function to calculate final droop gains incorporating rate limits
function [Rd_f1, Rd_f2, Rd_f3] = calculateDroopGains(Delta_Rd1, Delta_Rd2, Delta_Rd3, Rd,
Rd_fi_initial, K1, K2, K3, Ts)
  persistent Rd_f1_previous Rd_f2_previous Rd_f3_previous
  if isempty(Rd_f1_previous)
    Rd_f1_previous = Rd_fi_initial;
  end
  if isempty(Rd_f2_previous)
    Rd_f2_previous = Rd_fi_initial;
  end
  if isempty(Rd_f3_previous)
    Rd_f3_previous = Rd_fi_initial;
  end
  rate_limit = 0.0001;
  max_change = rate_limit * Ts;
  min_change = −max_change;
  input1 = Delta_Rd1 + Rd / K1;
  input2 = Delta_Rd2 + Rd / K2;
  input3 = Delta_Rd3 + Rd / K3;
  Rd_f1 = rateLimiter(input1, Rd_f1_previous, max_change, min_change);
  Rd_f2 = rateLimiter(input2, Rd_f2_previous, max_change, min_change);
  Rd_f3 = rateLimiter(input3, Rd_f3_previous, max_change, min_change);
  Rd_f1_previous = Rd_f1;
  Rd_f2_previous = Rd_f2;
  Rd_f3_previous = Rd_f3;
end
% Helper function to apply rate limiting
function output = rateLimiter(input, previous, max_change, min_change)
  change = input − previous;
  limited_change = max(min(change, max_change), min_change);
  output = previous + limited_change;
end
```

The preceding example can be repeated with similar success by substituting the generically or specifically described components and/or operating conditions of embodiments of the present invention for those used in the preceding examples.

Optionally, embodiments of the present invention can include a general or specific purpose computer or distributed system programmed with computer software implementing steps described above, which computer software may be in any appropriate computer language, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Although the specification describes various “steps” that are preferably performed, it is to be understood that such description is merely to afford the reader with the most preferred embodiment of the present invention. The various steps need not strictly occur in the numbered order that is presented within the specification. The terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given. All computer software disclosed herein may be embodied on any non-transitory computer-readable medium (including combinations of mediums).

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference. Unless specifically stated as being “essential” above, none of the various components or the interrelationship thereof are essential to the operation of the invention. Rather, desirable results can be achieved by substituting various components and and/or reconfiguration of their relationships with one another.

What is claimed is:

1. A method of variable-droop state of charge (“SoC”) correction for a plurality of parallel grid-forming battery energy storage systems (“BESSs”), each of the BESSs comprising at least one battery stack, the method comprising:
measuring a voltage of each of the at least one battery stack to determine a SoC for each of the plurality of parallel grid-forming BESSs;
computing an average SoC of the plurality of parallel grid-forming BESSs for a microgrid;
calculating an unsaturated droop adjustment value for at least one of the plurality of parallel grid-forming BESSs;
dynamically adjusting a droop gain limit for the at least one of the plurality of parallel grid-forming BESSs based at least in part on loading of a grid-forming converter of the at least one of the plurality of grid-forming BESSs;
calculating a saturated droop gain adjustment value;
applying a droop gain to the at least one of the plurality of parallel grid-forming BESSs without exceeding the calculated saturated droop gain adjustment value; and
dedrooping the at least one of the plurality of parallel grid-forming BESSs by calculating a reference voltage for the grid-forming converter using the saturated droop gain adjustment value.

2. The method of claim 1 wherein calculating an unsaturated droop adjustment value comprises determining a difference between the computed average SoC and the determined SoC of the at least one of the plurality of parallel grid-forming BESSs.

3. The method of claim 2 wherein calculating an unsaturated droop adjustment value for the at least one of the plurality of parallel grid-forming BESSs further comprises multiplying the determined difference by a sign of an inductor current of the grid-forming converter.

4. The method of claim 1 comprising scaling the calculated unsaturated droop adjustment value by a capacity ratio of the of the at least one of the plurality of parallel grid-forming BESSs to account for a relative power capacity.

5. The method of claim 4 further comprising applying a factor to adjust a convergence rate of the determined SoC for the at least one of the plurality of parallel grid-forming BESSs.

6. The method of claim 1 wherein the computed average SoC of the plurality of parallel grid-forming BESSs is communicated to a droop gain calculator of each of the plurality of parallel grid-forming BESSs.

7. The method of claim 1 wherein calculating the unsaturated droop adjustment value comprises first determining a difference between the computed average SoC of the plurality of parallel grid-forming BESSs and the SoC of all battery stacks connected to the grid-forming converter.

8. The method of claim 1 wherein dynamically adjusting the droop gain limit comprises preventing overloading by dynamically adjusting the droop gain adjustment based on a loading condition of the grid-forming converter.

9. The method of claim 1 wherein dynamically adjusting a droop gain limit further comprises applying an adjustable parameter to adjust a range of the droop gain limit.

10. The method of claim 1 wherein calculating the saturated droop gain adjustment value comprises dynamically restricting the unsaturated droop adjustment value to a percentage or other proportional relationship of a basic droop gain, based on real-time system parameters.

11. The method of claim 1 further comprising compensating for voltage drop by calculating the reference voltage for a grid-forming converter using the saturated droop gain adjustment value, calculating a voltage drop caused by droop control for each grid-forming converter of the of the plurality of parallel grid-forming BESSs, and calculating an average of the voltage drops of all grid-forming converters of the plurality of parallel grid-forming BESSs and adding the average of the voltage drops to the reference voltage for each of the grid-forming converters.

12. The method of claim 1 further comprising calculating the reference voltage for a grid-forming converter using the saturated droop gain adjustment value.

13. The method of claim 1 wherein applying droop gain to the at least one of the plurality of parallel grid-forming BESSs without exceeding the calculated saturated droop gain adjustment value comprises applying the saturated droop gain adjustment value in response to the detection of SoC discrepancies among batteries exceeding a predetermined criteria.

14. The method of claim 13 wherein the predetermined criteria comprises a SoC of the batteries not deviating by more than 80% between a highest state of charge and a lowest SoC.

15. A variable-droop state of charge (“SoC”) management system for a direct current microgrid having a plurality of parallel grid-forming battery energy storage systems (“BESSs”), the system comprising:
each of the plurality of parallel grid-forming BESSs comprising at least one battery stack;
a processor and/or microcontroller configured and coupled to measure a voltage of each of the at least one battery stack to determine a SoC for each of the plurality of parallel grid-forming BESSs;
said processor and/or microcontroller configured to:
compute an average SoC of the plurality of parallel grid-forming BESSs;
calculate an unsaturated droop adjustment value for at least one of the plurality of parallel grid-forming BESSs;
dynamically adjust a droop gain limit for the at least one of the plurality of parallel grid-forming BESSs based at least in part on loading of a grid-forming converter of the at least one of the plurality of grid-forming BESSs;
calculate a saturated droop gain adjustment value;
apply a droop gain to the at least one of the plurality of parallel grid-forming BESSs without exceeding the calculated saturated droop gain adjustment value; and
dedroop the at least one of the plurality of parallel grid-forming BESSs by calculating a reference voltage for the grid-forming converter using the saturated droop gain adjustment value.

16. The variable-droop SoC management system of claim 15 wherein said processor and/or microcontroller is further configured to determine a difference between the computed average SoC and the determined SoC of the at least one of the plurality of parallel grid-forming BESSs.

17. The variable-droop SoC management system of claim 15 wherein said processor and/or microcontroller is further configured to apply a factor to adjust a convergence rate of the determined SoC for the at least one of the plurality of parallel grid-forming BESSs.

18. The variable-droop SoC management system of claim 15 wherein said variable-droop SoC management system is configured to prevent overloading by dynamically adjusting the droop gain adjustment based on a loading condition of the grid-forming converter.

19. The variable-droop SoC management system of claim 15 wherein said processor and/or microcontroller is further configured to dynamically restrict the unsaturated droop adjustment value to a percentage or other proportional relationship of a basic droop gain, based on real-time system parameters.

20. The variable-droop SoC management system of claim 15 wherein said processor and/or microcontroller is further configured to apply the saturated droop gain adjustment value in response to the detection of SoC discrepancies among batteries exceeding a predetermined threshold.
